(19) United States
(12) Patent Application Publication
(10) Pub. No.: US 2013/0268412 A1
(43) Pub. Date: Oct. 10, 2013

(54) System and Method for Selectively Populating an Itemized Display

(71) Applicants: Gerardo Camacho, Murrieta, CA (US); Stephen Ellis, Murrieta, CA (US); Christian Arzola, Lake Forest, CA (US)

(72) Inventors: Gerardo Camacho, Murrieta, CA (US); Stephen Ellis, Murrieta, CA (US); Christian Arzola, Lake Forest, CA (US)

(21) Appl. No.: 13/440,867

(22) Filed: Apr. 5, 2012

(51) Int. Cl. G06Q 30/06

(52) U.S. Cl. CPC G06Q 30/0603
USPC 705/27.1

(57) ABSTRACT

A first catalog of items associated with item characteristics Cᵢₘ, describing the items is converted into a display catalog of the items. A plurality of item parameters Pᵢ are defined for the items of the first catalog. A first generation module generates a first identifier for each item in the first catalog. The first identifier comprises a series of the item characteristics for each of the parameters associated with the item. A hierarchy prioritizes item parameters and their associated characteristics. A second generation module generates a second identifier based on the first identifier and the hierarchy. The second identifier comprises a series of item characteristics that is a subset of the characteristics included in the first identifier. A display generator generates display catalog from the second catalog by selectively populating a display medium according to the priority of each characteristic and associated parameter of the second identifier.

### BACKGROUND OF THE INVENTION

### Field of the Present Disclosure

The invention relates generally to a system and method for selectively populating an itemized display.

Companies that sell numerous amounts of items require a system of identifying and keeping track of the items offered. At the present moment, item identification numbers are either randomly or sequentially generated. When item numbers are so generated, adjusting catalogs, websites, inventory, etc. becomes time consuming because in most instances, someone has to manually search for the item number among thousands of random entries to make the adjustment. For example, a supplier who discontinues an item must first search for the item number among the thousands offered before the item can be deleted. Grouping items together, so as to form a logical catalog is also time consuming because the item numbers have no inherent relationship. To layout a catalog, one must manually organize the items according to characteristics determined ad hoc. In addition to being time consuming to set up, oftentimes these relationships are not the same relationships that consumers think of and the ability of consumers to search the relevant sections of a large catalog to find a desired part is reduced. Because setting these relationships is time consuming, it is generally done only once. Thus, catalog generation is a ‘one size fits all’ approach. A similar one-size-fits-all approach is evident when manufacturers or suppliers desire the generation of internal reports based on offered items. Each item must be individually sought out and either included or excluded from the report. This approach is vastly inefficient. This is further unfortunate because optimal identification of items may increase ‘hits’ in a search engine.

It is therefore desirable to implement a system and method whereby an itemized display may be automatically populated according to selected item criteria. It is further desirable to create an efficient way to populate displays, e.g. product catalogs, internal reports, web pages, etc., using a selected set of item criteria. It is further desirable that the selected set of criteria be variable based on the intended audience of the display.

### BRIEF SUMMARY OF THE INVENTION

This disclosure teaches certain benefits which give rise to the objectives described below.

A primary objective inherent in the above described apparatus and method of use is to provide advantages not taught by the prior art.

Another objective is to allow for the selective population of itemized displays.

Another objective is to allow for the selective population of itemized displays based on the implementation of hierarchies that prioritize item parameters and features according to the desired function of the display.

Other features and advantages of the present invention will become apparent from the following more detailed description, taken in conjunction with the accompanying drawings, which illustrate, by way of example, the principles of the presently described system and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 illustrates a generalized flow diagram according to embodiments of the present invention;

FIG. 2 illustrates an example of a system on which embodiments of the present invention may be implemented;

FIG. 3 illustrates a generic hierarchy according to embodiments of the present invention;

FIG. 4a-4e illustrate exemplar hierarchies according to embodiments of the present invention; and

FIG. 5 illustrates a schematic of an exemplar hierarchy according to Table 1.

### DETAILED DESCRIPTION OF THE INVENTION

The above described drawing figures illustrate the described system and its method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present system and method of use.

The present invention is directed towards converting a first catalog 100 of items with associated item characteristics Cᵢₘ that describe the items into a display catalog 500. The first catalog comprises a list of items, each item being associated with a first identifier 10 that is preferably unique. The catalogs may be in the format of databases or any other electronic format, such as a spreadsheets or texts. The catalogs may be created, expanded, updated or maintained based on any such format. The present application will describe the invention in terms of catalogs, however, in the context of the present invention, the terms catalog and database should not be construed as limited to any particular type of structure, but rather as broadly referring to any list or sequence in which items are accompanied by identifiers of their characteristics.

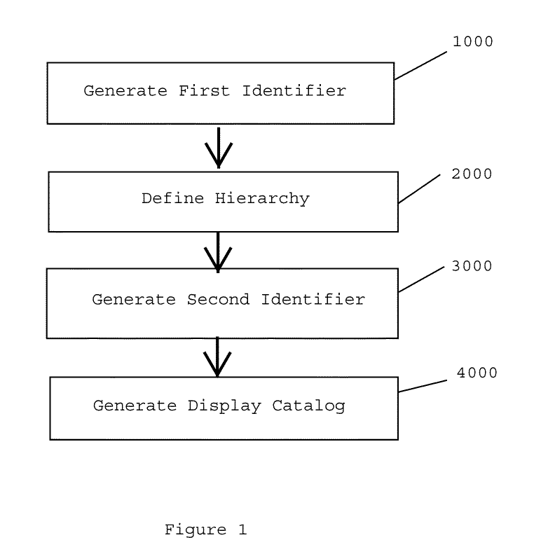

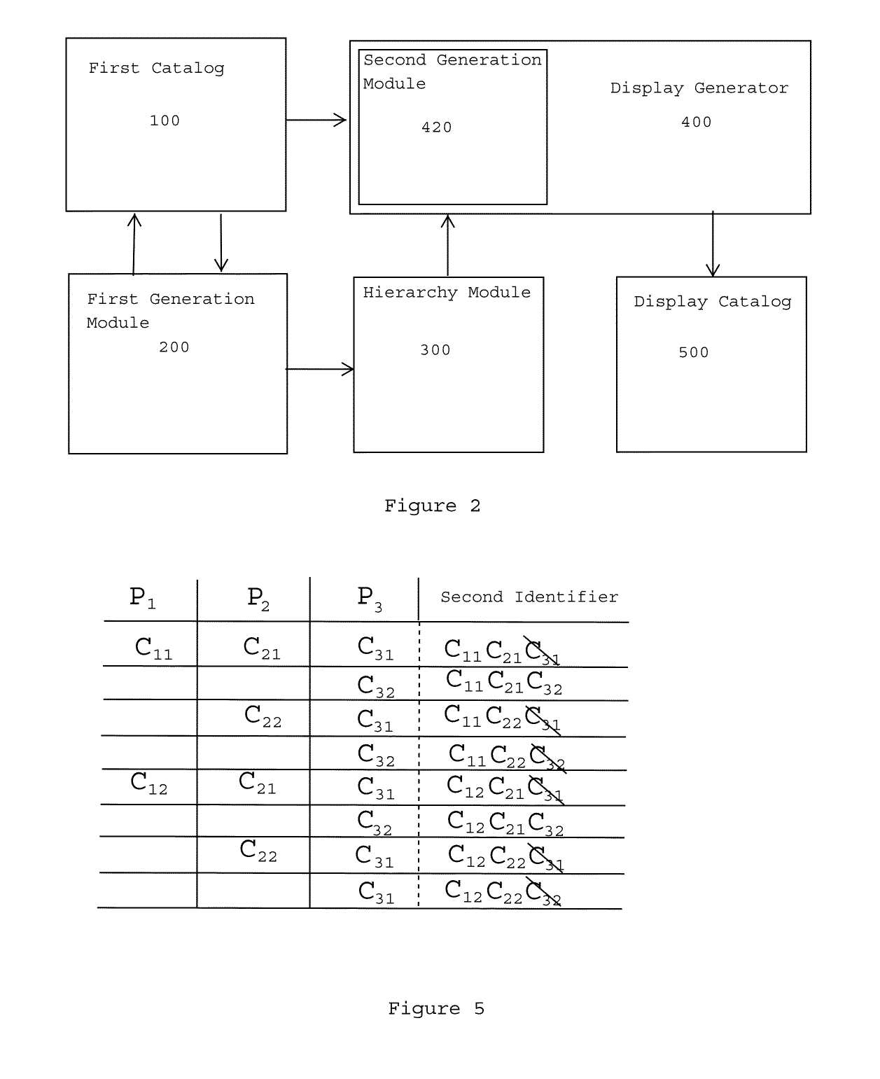

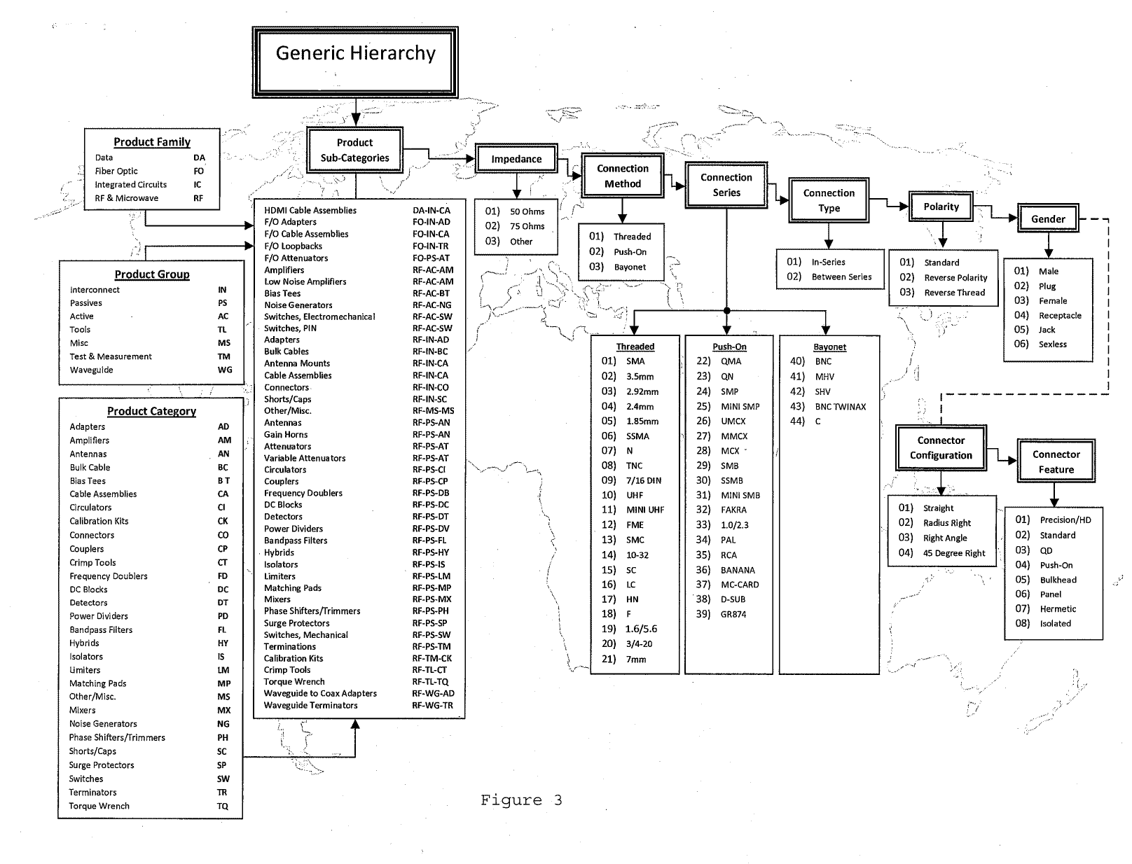

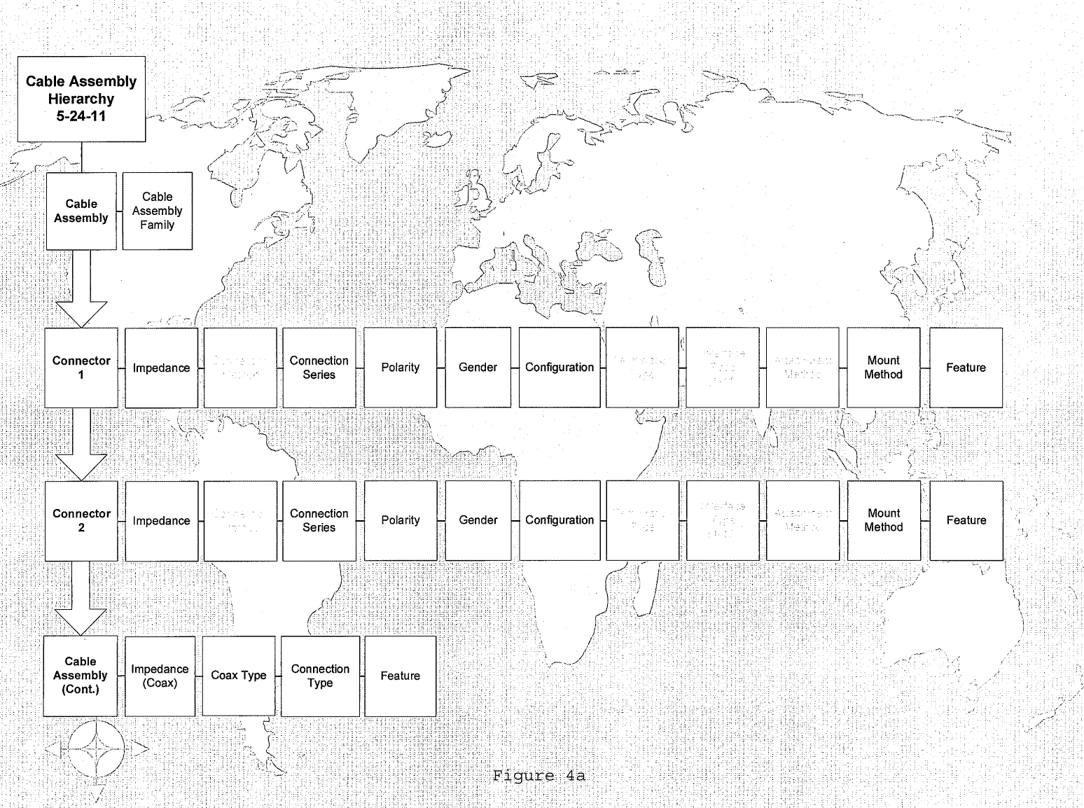

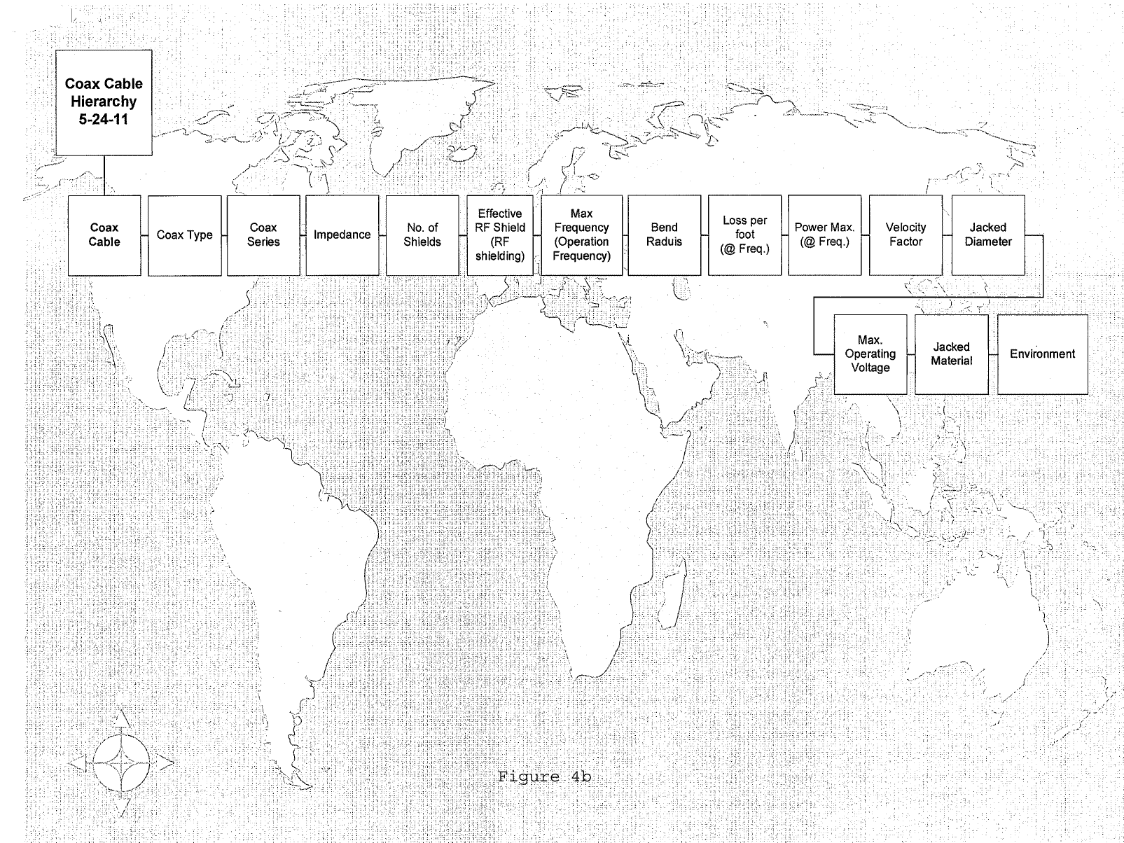

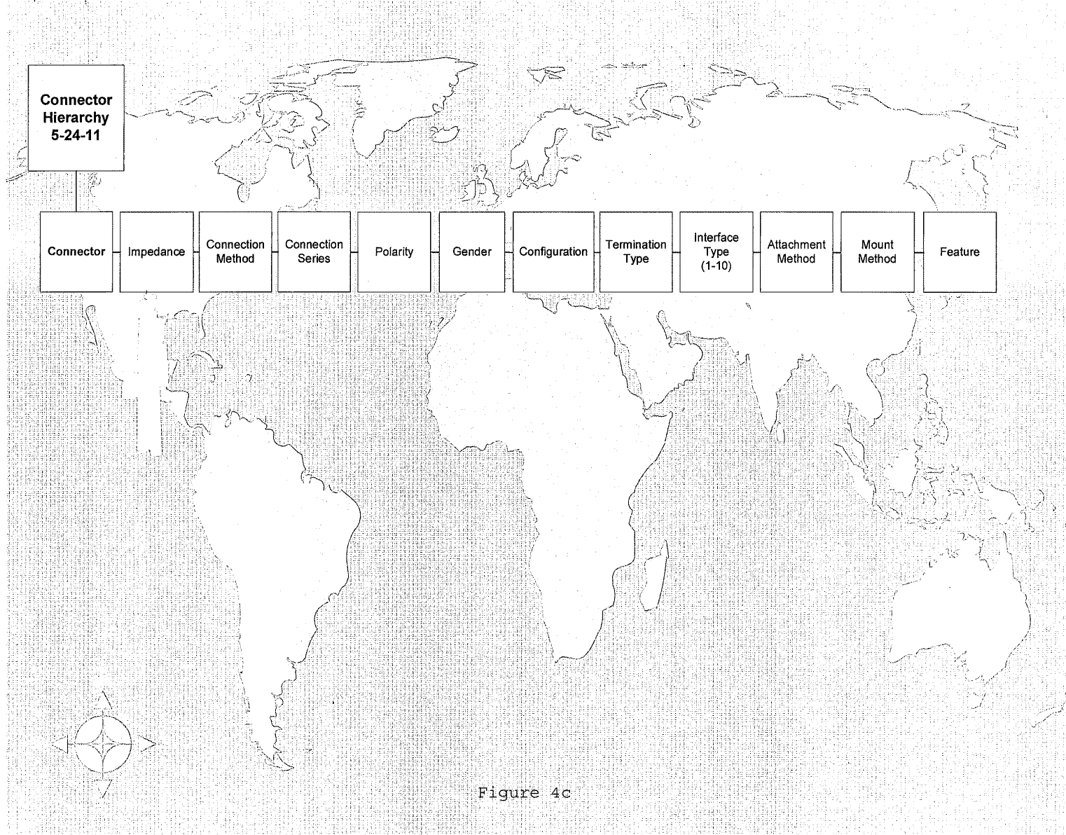

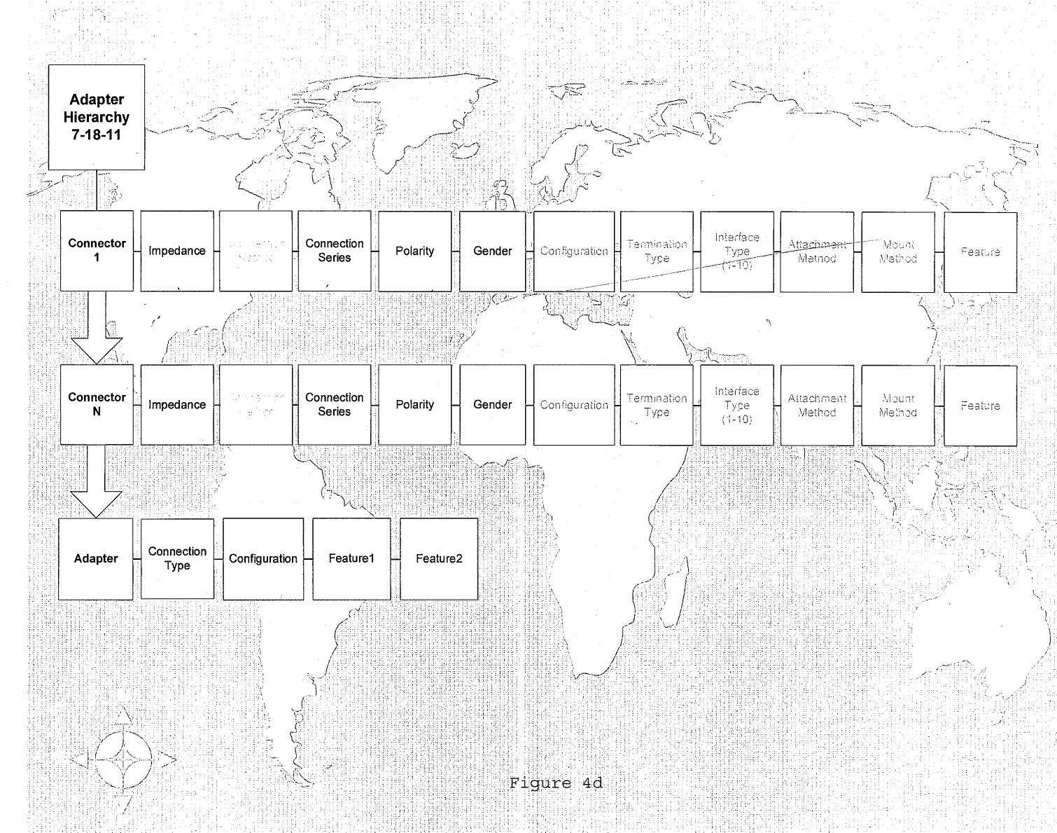

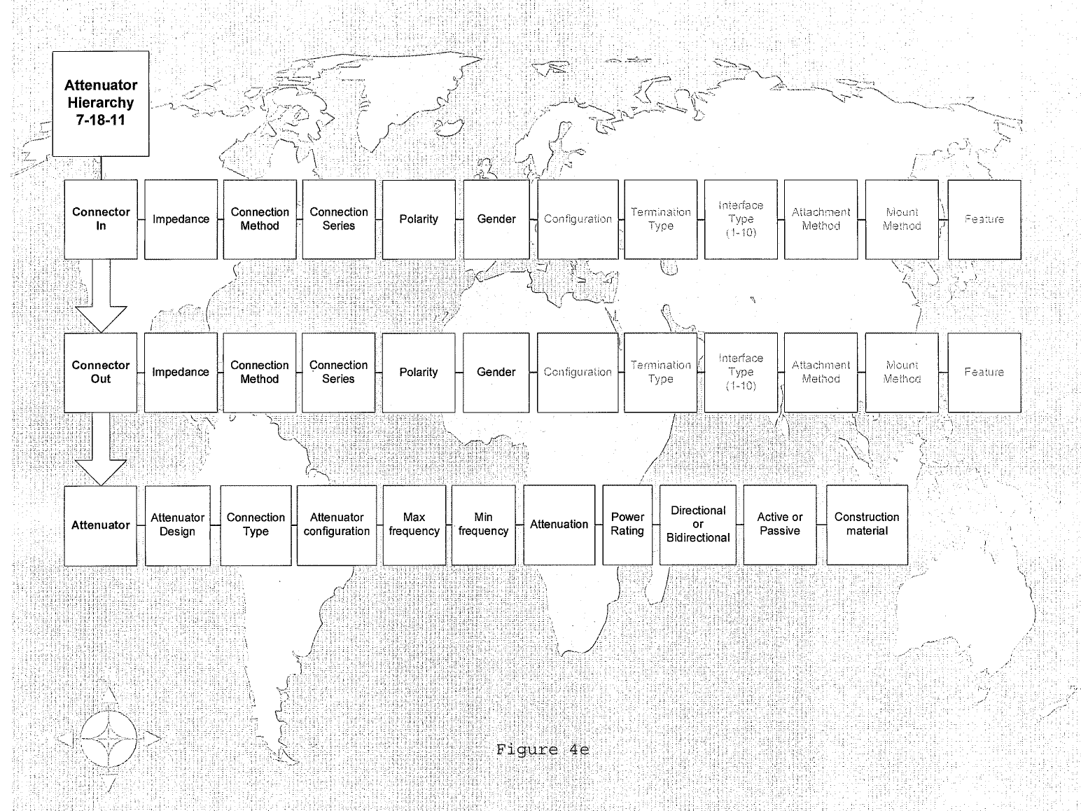

FIG. 1 shows a generalized flow diagram for implementation of the present invention. In step 1000, a first identifier is generated for each item in a catalog of items. In step 2000, a hierarchy is defined according to item characteristics and associated parameters. In step 3000, a second identifier is generated for each item based on the first identifier and the hierarchy. In step 4000, a display catalog is generated based on the second identifier and the hierarchy. These steps are discussed more fully below with reference to FIGS. 1 and 2.

The process is preferably used to create the display catalog from the existing first catalog. This is important when the display catalog presenting item characteristics in a different format is desired to meet certain business requirements, or to satisfy unique preferences of the ultimate recipient of the display catalog. For example, an item retailer may wish to purchase items from a wholesaler having specific characteristics that, while important to the particular retailer, are of ancillary importance to the wholesaler. Thus, the wholesaler's catalog of items may be organized in such a way as to make the search for items having the retailer's specified characteristics difficult and inefficient. Reorganization of the items into a display catalog specifically tailored to the demands of the retailer would thus promote efficiency. The present invention may also be useful to reconfigure an existing catalog (of the wholesaler for example) to accommodate changes in industry or the marketplace. For example, an item may be primarily searched for (i.e. distinguished) by one characteristic, but as time goes on, that characteristic may become industry standard and so another characteristic may take its place as the defining characteristic of the item or class of items.

A system and method for generating a display catalog of items from a first catalog of items according an embodiment of the present invention will now be described with reference to FIGS. 1 and 2. For ease of illustration, the present embodiment will be discussed with reference to a limited number of catalogs, item parameters and item characteristics. However, numerical indicators such as ‘first’, ‘second’, ‘third’ and ‘fourth’ are intended only in the most general sense to illustrate relationships between parameters, characteristics, and parameters and characteristics. It should be understood that the present invention is specifically contemplated to extend to any number of a plurality of parameters and characteristics.

Each of a plurality of items Iᵢ in a first catalog 100 has a plurality of item characteristics Cᵢₘ associated therewith. These item characteristics indicate features or attributes of the items, or may indicate technological fields, broad or narrow functionality, or means of accomplishing said functions. A plurality of item parameters Pᵢ are defined for the items of the first catalog. Each item characteristic is associated with an item parameter while a plurality of item parameters are associated with each item and each item parameter is associated with a plurality of item characteristics.

An item may have associated with it at least a first P₁, second P₂, and third P₃ parameters, the first parameter having at least first C₁₁ and second C₁₂ characteristics associated with it, the second parameter having at least third C₂₁ and fourth C₂₂ characteristics associated with it, and the third parameter having at least fifth C₃₁ and sixth C₃₂ characteristics associated with it. For example, impedance may be a first parameter associated with electrical cables having one of the following impedance values (i.e. characteristics): 50 ohms, 75 ohms, or other; and length may be a second parameter associated with electrical cables having one of the following lengths (i.e. characteristics): 12 inches, 24 inches, or other.

A first generation module 200 generates a first identifier 10 for each item in the first catalog. The first identifier is associated with each item comprising a series of the item characteristics, or alphanumeric indicators thereof, for each of the parameters associated with the item. A first identifier for an item may comprise at least the first characteristic, the fourth characteristic and the fifth characteristic, or alphanumeric indicators thereof. For example, the above electrical cable may have the first identifier 50 ohm, 12 inch electrical cable or an alphanumerical indicator thereof.

Additionally, at least one first identifier may be incomplete. That is, while the parameters associated with an item may be known and assigned to the item, the specific item characteristic associated with a given parameter may be unknown. In such circumstances, the first identifier may be generated with one or more null characteristics indicating the specific item characteristic associated with the parameter is currently unknown. The item characteristic then may be discovered and exchanged for the null characteristic. A request may be sent to a third party, for example a manufacturer or supplier of the item, indicating the parameter for which there is an unknown characteristic and requesting the third party provide the item's characteristic associated with the parameter. Also, the first generation module may be operable to edit/update the first identifiers to accommodate changes in vernacular, additional parameters and/or characteristics, merging and/or splitting of parameters and/or characteristics, and other changes to identification convention.

Once a first identifier is associated with each item, a hierarchy module 300 generates a hierarchy for the item parameters and for their associated characteristics. The first parameter may be of equal or greater priority to the second parameter. The second parameter may be equal or greater priority to the third parameter. Within the first parameter, the first characteristic may be of equal or greater priority to the second characteristic. Within the second parameter, the third characteristic may be of equal or greater priority to the fourth characteristic. Within the third parameter, the fourth characteristic may be of equal or greater priority to the sixth characteristic. Such a hierarchy is illustrated for example in FIG. 5.

The hierarchy may be generated partially or completely by a user input, or its generation may be partially or wholly autonomous. In some embodiments, the hierarchy module tracks, via network communication, searching strategies used in searching for items in the first catalog and generates a hierarchy based thereon. In some embodiments, the hierarchy module generates the hierarchy based on relative volume of sales of items having certain characteristics.

A second generation module 420 generates a second identifier 20 based on the first identifier and the hierarchy. The second identifier comprises a series of item characteristics (or alphanumeric indicators thereof) that is a subset of the characteristics included in the first identifier. For example, the second identifier may comprise characteristics selected from the following matrix representation of an example hierarchy, whereby i indicates the associated parameter and its priority level, and m indicates the characteristic and its priority level:

TABLE 1

| | | | | |
|---|---|---|---|---|
| C₁₁ | C₂₁ | C₃₁ | . . . | Cᵢ₁ |
| C₁₂ | C₂₂ | C₃₂ | . . . | Cᵢ₂ |
| . . . | . . . | . . . | . . . | . . . |
| C₁ₘ | C₂ₘ | C₃ₘ | . . . | Cᵢₘ |

In generating the second identifier according to the hierarchy, a lesser parameter may be included/excluded independent of at least one greater parameter. For example, FIG. 5 illustrates a hierarchy where the second parameter is included independent of the first parameter.

In other words, the second identifier will contain a characteristic associated with the second parameter regardless of the characteristic associated with the first parameter. In other words, no matter which C₁ₘ the first identifier has, the second identifier will have a C₂ₘ. This is particularly important for high priority parameters, such as technology field, broad function, and particular function, which apply to all items and whose presence is required to make broad categorizations.

In generating the second identifier according to the hierarchy, lesser parameter may be included/excluded dependent on the characteristic of at least one greater parameter. For example, FIG. 5 illustrates a hierarchy where the third parameter may be included/excluded depending on the second parameter. In other words, if the second parameter has the fourth characteristic C₂₂, then the second identifier will not have a third parameter (or associated characteristic C₃ₘ). On the other hand, if the second parameter has the third characteristic C₂₁, then the second identifier will have a third parameter (or associated characteristic C₃ₘ). This is particularly important where parameters lower in priority, such as particular features, are applicable only to items having certain characteristics of higher priority parameters. For example, an item classified according to its higher priority parameters as an electrical cable would not require lower priority parameters for features not present in electrical cables, such as being active or passive.

In generating the second identifier according to the hierarchy, parameter may be included/excluded dependent on its own characteristic. For example, FIG. 5 illustrates a hierarchy where the third parameter may be included/excluded depending on the characteristic assigned to it. In other words, the if the third parameter has the fifth characteristic C₃₁, then the second identifier will not have the third parameter. On the other hand, if the third parameter has the fifth characteristic C₃₂, then the second identifier will have the third parameter. This is particularly important where the second identifier generated is an item name and the fifth characteristic is an industry standard whose presence is assumed when not specifically stated in an item name.

Additionally, the hierarchy may comprise at least one null parameter. The null parameter may be associated with an null characteristic for indicating a relationship between parameters. For example, in <gender1> <to > <gender2> the <to > is a null parameter prioritized between <gender1> and <gender2> so that a connector may have the second identifier (or portion thereof) of male-to-female connector. The presence of null parameters in the hierarchy is particularly important when the second identifier generated is an item name and the presence of the null identifier signifies a relationship between parameters.

In generating the second identifier according to the hierarchy and the first identifier, the second generation module may implement any combination of the above steps, or none at all. The second generation module may thus generate a second catalog 460 comprising a list of items identified by second identifiers.

A display generator 400 may generate a display catalog 500 from the second catalog by selectively populating a display medium according to the priority of each characteristic and associated parameter of the second identifier. The display catalog may be organized according to the hierarchy. Items may be organized according to the first parameter, then the second parameter, then the third parameter. Within the first parameter, items may be organized according to the first characteristic then the second characteristic. Within the second parameter, items may be organized according to the third characteristic then the fourth characteristic. Within the third parameter, items may be organized according to the fifth characteristic then the sixth characteristic. As illustrated in FIG. 5, an exemplary item organization would be C₁₁C₂₁, C₁₁C₂₁C₃₂, C₁₁C₂₂, C₁₂C₂₁, C₁₂C₂₁C₃₂, C₁₂C₂₂. It should be appreciated that while this example assigns one secondary identifier per item, the secondary identifier for each item comprises a subset of the item characteristics of the first identifier of that item, and therefore a given secondary identifier may indicate multiple items. Thus, one or more items may be referenced by the secondary identifier C₁ₘC₂ₘ . . . Cᵢₘ, and selective population of the display medium may cause those items so referenced to be grouped together, as illustrated in FIG. 5.

It should be understood that while the second catalog and the display catalog are described herein as separate for ease of illustration, it is contemplated that the second catalog and the display catalog may be one and the same. Accordingly, the display catalog generator may comprise the second generator.

The hierarchy preferably prioritizes certain parameters and characteristics over others so as to tailor the display catalog to its end recipient.

In some embodiments, the display medium may comprise a printed catalog of a wholesaler for distribution to various retailers who deal in subsets of the items offered by the wholesaler. By defining a hierarchy for each class of retailers, customized printed display catalogs may be generated which promote the efficient identification of items available for purchase by the retailer.

In some embodiments, the second identifier may comprise an item name stored in a database, and the display generator may be a search engine for the database. By defining a hierarchy that groups item parameters together by common industry or consumer vernacular, the accuracy of ‘hits’ by the search engine may be increased. Because the hierarchy is alterable according to the changes in naming conventions, accuracy of the search engine may be maintained at a high level.

In some embodiments, the display medium may comprise a drop-down-type search feature on a website. By defining a hierarchy of most-important features to less-important features, a series of dropdown menus based on the hierarchy may permit a website user to create a customized display catalog limited to the items that fit the users requirements.

Other applications may include report generation and inventory updating.

An example of a computer system on which the present invention may be implemented will now be described. The computer system comprises a bus or other communication means for communicating information, and a processing means such as a processor coupled with the bus for processing information. The computer system further comprises a random access memory (RAM) or other dynamic storage device (i.e. main memory) coupled to the bus for storing information and instructions to be executed by the processor. The main memory also may be used for storing temporary variables or other intermediate information during execution of instructions by the processor. The computer system may also include a read only memory (ROM) or other static information and instructions for the processor. A data storage device such as a magnetic disk or optical disk and its corresponding drive may also be coupled to the computer system fro storing information and instructions. The computer system can also be coupled via the bus to an electronic display device for displaying information to an end user, such as an LCD screen. An alphanumeric input device may be coupled to the bus for communicating information and command selections to the processor. A cursor control, such as a mouse, may be coupled to the bus for communicating information and command selections to the processor and for controlling cursor movement on the display. A printer, or other such physical display generator for creating graphic displays, can also be coupled to the bus. A communication device may be also coupled to the bus, and may include a modem, a network interface card, or other well known interface devices. In this manner, the computer system may be coupled to a number of clients or servers via a conventional network infrastructure, such as Intranet or Internet. It will be appreciated that a lesser or more equipped computer system may be desirable for certain implementations.

It should be noted that while the steps described herein may be performed under the control of a programmed processor, in alternative embodiments, the steps may be fully or partially implemented by any programmable or hard coded logic. Additionally, the method of the present invention may be performed by any combination of programmed general purpose computer components or custom hardware components. Therefore, nothing disclosed herein should be construed as limiting the present invention to a particular embodiment where the recited steps are performed by a specific combination of hardware components.

The present invention includes various steps. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. Moreover, the present invention may also be downloaded as a computer program product, wherein the program may be transferred from a remote computer to a requesting computer by way of data signals embodied in a carrier wave or other propagation medium via a communication link.

Importantly, while embodiments of the present invention are described with reference to mapping one catalog format into another, the method and apparatus described herein are equally applicable to the conversion of any sort of database which requires a change in format. For example, the techniques described herein are thought to be useful in connection with databases for inventory management and client or customer management.

The enablements described in detail above are considered novel over the prior art of record and are considered critical to the operation of at least one aspect of the system and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its

[symbol]

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method for generating a display catalog from a first catalog of items comprising one or more item characteristics, the method comprising the steps of:
defining a plurality of item parameters, each item characteristic corresponding to exactly one item parameter, each item parameter corresponding to one or more item characteristics;
generating a first identifier for each item, the first identifier comprising a series of item characteristics;
defining a hierarchy for prioritizing parameters according to an intended recipient of the display catalog;
selectively populating the display catalog based on the first identifier and the hierarchy.

2. The method of claim 1, wherein the step of selectively populating the display catalog comprises the steps of:
generating a second identifier for each item based on the first identifier and the hierarchy, the second identifier comprising a series of item characteristics that is a subset of the first identifier;
mapping the second identifier to the display catalog according to the second identifier and the hierarchy.

3. The method of claim 3, wherein mapping the second identifiers to the display catalog comprises grouping items according to shared parameters of their second identifiers, and according to shared characteristics of said shared parameters.

4. The method of claim 1,
wherein the parameter hierarchy includes at least a first parameter that is of greater priority to at least a second parameter;
wherein the first and second parameters each have at least a first characteristic associated therewith;
wherein one or more of the first and second parameters may have at least a second characteristic associated therewith; and
wherein, the first characteristic is of greater priority to the second characteristic.

5. The method of claim 4, wherein the step of selectively populating the display catalog comprises the steps of:
generating a second identifier for each item based on the first identifier and the hierarchy, the second identifier comprising a series of item characteristics that is a subset of the first identifier;
mapping the second identifier to the display catalog according to the second identifier and the hierarchy.

6. The method of claim 5, wherein the second identifier contains a characteristic associated with a second parameter independent of the characteristic of the first identifier associated with the first parameter.

7. The method of claim 5, wherein the second identifier may contain a characteristic associated with a second parameter depending on the characteristic of the first identifier associated with the first parameter.

8. The method of claim 5, wherein the second identifier may contain a characteristic associated with a second parameter depending on the characteristic of the first identifier associated with the second parameter.

9. The method of claim 5, wherein mapping the second identifiers to the display catalog comprises grouping items according to shared parameters of their second identifiers, and according to shared characteristics of said shared parameters.

10. The method of claim 6, wherein mapping the second identifiers to the display catalog comprises organizing item placement within the display catalog such that items whose secondary identifiers contain the first characteristic of the first parameter and items whose secondary

[symbol]

11. The method of claim 1, wherein generating the first identifier comprises the step of:
receiving an item characteristic in response to a request indicating the item parameter associated with the item characteristic.

12. The method of claim 1, wherein the display catalog is at least one of: a database, a spreadsheet, a printed catalog, and an inventory list.

13. The method of claim 1, wherein the first identifier of each item is unique among the items.

14. A system for generating a display catalog of items comprising:
a display medium;
a first catalog of items comprising one or more item characteristics, each item characteristic corresponding to an item parameter, each item parameter corresponding to one or more item characteristics;
a first generation module for generating a first identifier for each item, the first identifier comprising a series of item characteristics;
a hierarchy generation module for defining a hierarchy for prioritizing parameters according to an intended recipient of the display catalog;
a display catalog generation module for selectively populating the display medium based on the first identifier and the hierarchy.

15. The system of claim 14, wherein the display catalog generation module comprises:
a second generation module for generating a second identifier for each item based on the first identifier and the hierarchy, the second identifier comprising a series of item characteristics that is a subset of the first identifier; and
wherein the display catalog generation module maps the second identifier to the display medium according to the second identifier and the hierarchy.

16. The system of claim 15, wherein items are mapped to the display catalog according to shared parameters of their second identifiers, and according to shared characteristics of said shared parameters.

17. The system of claim 15,
wherein the parameter hierarchy includes at least a first parameter that is of greater priority to at least a second parameter;
wherein the first and second parameters each have at least a first characteristic associated therewith;
wherein one or more of the first and second parameters may have at least a second characteristic associated therewith; and
wherein, the first characteristic is of greater priority to the second characteristic.

18. The system of claim 17, wherein the second identifier contains a characteristic associated with a second parameter independent of the characteristic of the first identifier associated with the first parameter.

19. The system of claim 17, wherein the second identifier may contain a characteristic associated with a second parameter depending on the characteristic of the first identifier associated with the first parameter.

20. The system of claim 17, wherein the second identifier may contain a characteristic associated with a second parameter depending on the characteristic of the first identifier associated with the second parameter.
